(19) United States
(12) Patent Application Publication
(10) Pub. No.: US 2020/0034494 A1
(43) Pub. Date: Jan. 30, 2020

(54) Barcode Reading and Display Assembly

(71) Applicant: Emmanuel Beauduy, Northford, CT (US)

(72) Inventor: Emmanuel Beauduy, Northford, CT (US)

(21) Appl. No.: 16/045,185

(22) Filed: Jul. 25, 2018

(51) Int. Cl. G06F 17/30; G06K 7/14; G06K 7/08; G06F 1/16; G09B 19/00

(52) U.S. Cl. CPC G06F 17/30991; G06K 7/1413; G09B 19/0092; G06F 1/1613; G06K 7/089

(57) ABSTRACT

A barcode reading and display assembly for presenting ingredients of an item to a user includes a computer system and a scanning device. The computer system is operationally coupled to a system of interconnected computer networks. A database that is positioned on the computer system comprises a plurality of tables. Each table comprises a list of ingredients for a respective item. The scanning device comprises a reader, a screen, and a transceiver. The reader is configured to read a barcode that is positioned on the respective item. The transceiver is positioned to communicate the barcode to the computer system and to receive the table, positioning the screen to display the list of ingredients.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98.

The disclosure and prior art relates to barcode reading assemblies and more particularly pertains to a new barcode reading assembly for presenting ingredients of an item to a user.

### (h) BRIEF SUMMARY OF THE INVENTION

An embodiment of the disclosure meets the needs presented above by generally comprising a computer system and a scanning device. The computer system is operationally coupled to a system of interconnected computer networks. A database that is positioned on the computer system comprises a plurality of tables. Each table comprises a list of ingredients for a respective item. The scanning device comprises a reader, a screen, and a transceiver. The reader is configured to read a barcode that is positioned on the respective item. The transceiver is positioned to communicate the barcode to the computer system and to receive the table, positioning the screen to display the list of ingredients.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a barcode reading and display assembly according to an embodiment of the disclosure.

FIG. 2 is an in-use view of an embodiment of the disclosure.

FIG. 3 is a block diagram of an embodiment of the disclosure.

### (j) DETAILED DESCRIPTION OF THE INVENTION

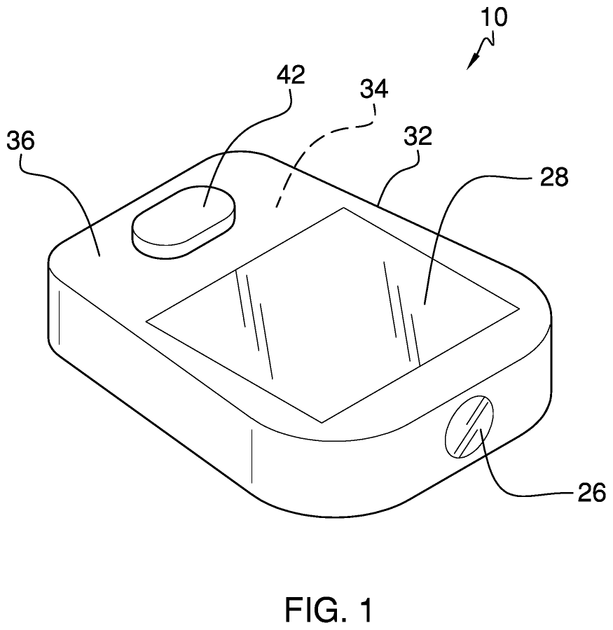

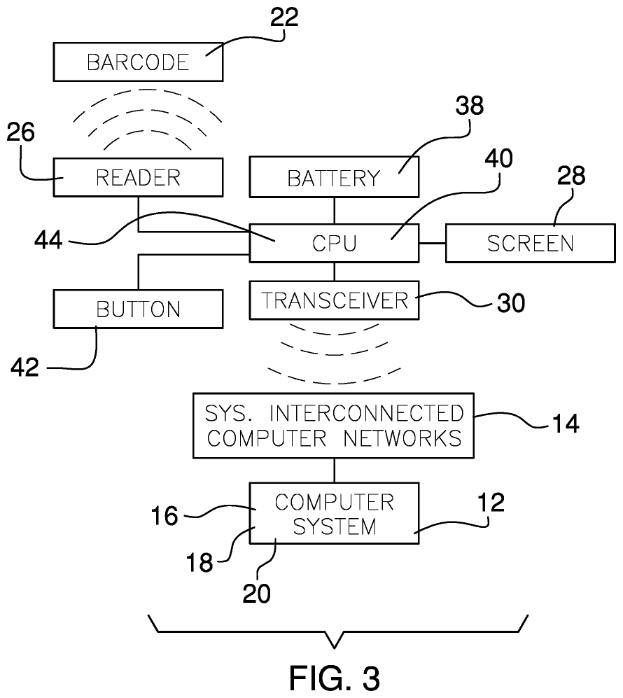

With reference now to the drawings, and in particular to FIGS. 1 through 3 thereof, a new barcode reading assembly embodying the principles and concepts of an embodiment of the disclosure and generally designated by the reference numeral 10 will be described.

As best illustrated in FIGS. 1 through 3, the barcode reading and display assembly 10 generally comprises a computer system 12 that is operationally coupled to a system of interconnected computer networks 14. A database 16 is positioned on the computer system 12. The database 16 comprises a plurality of tables 18. Each table 18 comprises a list of ingredients 20 for a respective item, such as a packaged food or beverage. A barcode 22 is positioned on the respective item.

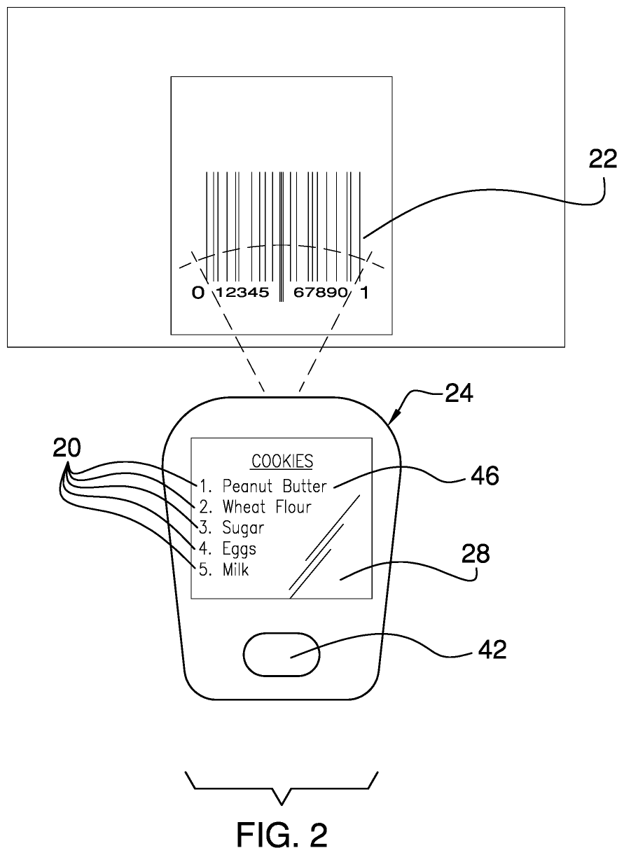

The assembly 10 comprises a scanning device 24. The scanning device 24 comprises a reader 26, a screen 28, and a transceiver 30. The reader 26 is configured to read the barcode 22, as shown in FIG. 2, positioning the transceiver 30 to communicate the barcode 22 to the computer system 12 and to receive the table 18. The screen 28 is positioned to display the list of ingredients 20. The assembly 10 enables a user to quickly access the list of ingredients 20 for the packaged food or the beverage.

The transceiver 30 is configured for wireless local area networking. The scanning device 24 comprises a housing 32 that define an interior space 34. The reader 26 and the transceiver 30 are coupled to the housing 32 and are positioned in the interior space 34. The screen 28 is coupled to a top 36 of the housing 32, as shown in FIG. 1.

A battery 38 and a microprocessor 40 are coupled to the housing 32 and are positioned in the interior space 34. The microprocessor 40 is operationally coupled to the battery 38, the reader 26, the screen 28, and the transceiver 30. A button 42 is coupled to the top 36 of the housing 32. The button 42 is depressible. The button 42 is operationally coupled to the microprocessor 40.

The button 42 is configured to be depressed to signal the microprocessor 40 to command the reader 26 to read the barcode 22. The microprocessor 40 is positioned to command the transceiver 30 to communicate the barcode 22 to, and to receive the table 18 from, the computer system 12 via the system of interconnected computer networks 14. The microprocessor 40 is positioned to command the screen 28 to display the list of ingredients 20.

Programming code 44 is positioned on the microprocessor 40 that enables the user to enter a command into the microprocessor 40 to analyze the table 18 for a specific ingredient 46, such as peanuts or gluten. The microprocessor 40 is positioned to emphasize the specific ingredient 46 on the screen 28. The programming code 44 is particularly useful to the user with a medical condition, such as an allergy, that requires the user to refrain from consumption of the specific ingredient 46.

In use, the button 42 is depressed to signal the microprocessor 40 to command the reader 26 to read the barcode 22. The transceiver 30 communicates the barcode 22 to the computer system 12 and receives the table 18. The screen 28 displays the list of iiigiedieiits 20 to tile user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A barcode reading and display assembly comprising:
a computer system operationally coupled to a system of interconnected computer networks;
a database positioned on the computer system, the database comprising a plurality of tables, each table comprising a list of ingredients for a respective item;
a barcode positioned on the respective item; and
a scanning device comprising a reader, a screen, and a transceiver wherein the reader is configured for reading the barcode positioning the transceiver for communicating the barcode to the computer system and for receiving the table positioning the screen for displaying the list of ingredients.

2. The assembly of claim 1, further including the transceiver being configured for wireless local area networking.

3. The assembly of claim 1, further including the scanning device comprising:
a housing defining an interior space, the reader and the transceiver being coupled to the housing and positioned in the interior space, the screen being coupled to a top of the housing;
a battery coupled to the housing and positioned in the interior space;
a microprocessor coupled to the housing and positioned in the interior space, the microprocessor being operationally coupled to the battery, the reader, the screen, and the transceiver; and
a button coupled to the top of the housing, the button being depressible, the button being operationally coupled to the microprocessor wherein the button is configured for depressing for signaling the microprocessor for commanding the reader for reading the barcode positioning the microprocessor for commanding the transceiver for communicating the barcode to the computer system via the system of interconnected computer networks and receiving the table via the system of interconnected computer networks wherein the microprocessor is positioned for commanding the screen for displaying the list of ingredients.

4. The assembly of claim 4, further including programming code positioned on the microprocessor enabling a user for entering a command into the microprocessor for analyzing the table for a specific ingredient positioning the microprocessor for emphasizing the specific ingredient on the screen.

5. A barcode reading and display assembly comprising:
a computer system operationally coupled to a system of interconnected computer networks;
a database positioned on the computer system, the database comprising a plurality of tables, each table comprising a list of ingredients for a respective item;
a barcode positioned on the respective item; and
a scanning device comprising a reader, a screen, and a transceiver wherein the reader is configured for reading the barcode positioning the transceiver for communicating the barcode to the computer system and for receiving the table positioning the screen for displaying the list of ingredients, the transceiver being configured for wireless local area networking, the scanning device comprising:
a housing defining an interior space, the reader and the transceiver being coupled to the housing and positioned in the interior space, the screen being coupled to a top of the housing,
a battery coupled to the housing and positioned in the interior space,
a microprocessor coupled to the housing and positioned in the interior space, the microprocessor being operationally coupled to the battery, the reader, the screen, and the transceiver,
a button coupled to the top of the housing, the button being depressible, the button being operationally coupled to the microprocessor wherein the button is configured for depressing for signaling the microprocessor for commanding the reader for reading the barcode positioning the microprocessor for commanding the transceiver for communicating the barcode to the computer system via the system of interconnected computer networks and receiving the table via the system of interconnected computer networks wherein the microprocessor is positioned for commanding the screen for displaying the list of ingredients, and
programming code positioned on the microprocessor enabling a user for entering a command into the microprocessor for analyzing the table for a specific ingredient positioning the microprocessor for emphasizing the specific ingredient on the screen.
